(19) United States
(12) Patent Application Publication
(10) Pub. No.: US 2014/0300461 A1
(43) Pub. Date: Oct. 9, 2014

(54) Personal Reminder System and Method of Use

(71) Applicant: Linda K. Stark, Montara, CA (US)

(72) Inventor: Linda K. Stark, Montara, CA (US)

(21) Appl. No.: 13/858,823

(22) Filed: Apr. 8, 2013

(51) Int. Cl. G08B 21/02

(52) U.S. Cl. CPC G08B 21/02
USPC 340/457

(57) ABSTRACT

A method of use of a personal reminder system, includes motion detectors and/or touch sensors installable adjacent strategic locations, where activation of the sensors by detection of motion such as door opening, closing, ignition turning, etc. is possible, which activate a audio play/record device (audio, digital, cell phone, etc) to play messages. The reminder device can be portable with low/high range motion sensors, battery operated, plug in, rechargeable, or built into a vehicle utilizing low range motion sensors, touch sensors, push/button switches, switches, and when triggered, the audio device plays the messages, thus serving as a reminder. Messages can be pre-recorded or ones user records.

### RELATED APPLICATION(S)

None.

### FIELD OF THE INVENTION

The present invention relates to an electronic reminder system and a method of use to improve children's safety in automobiles, to provide a timely and instantaneous audio reminder to parents and/or caregivers not to leave their child(ren) behind in their automobiles, and for other general reminder purposes.

### BACKGROUND OF THE INVENTION

The present invention relates to a method of use, a system that consists of a reminder message device, motion sensors, and optionally touch sensors, where the motion sensor/touch sensor triggers the reminder message device to play message(s) of a certain theme. The system can be built into any vehicle, or portable and attached near the ignition or driver's door handle, to help eliminate the risk of leaving children in a vehicle. The built into the vehicle reminder can also utilize touch sensors or switches connected to the ignition and/or driver's door. The portable reminder device can utilize both low and high motion sensors, switching to low or high motion sensor depending on the intended use, for use inside a vehicle as well as inside a home, office, store, or school.

It is very dangerous for children to be left in a vehicle, and more common than one may suspect. Tragic deaths have occurred when children have been forgotten and left in vehicles. Temperatures can soar in minutes inside a vehicle. On a hot day, within ten minutes the temperature inside a vehicle can rise twenty degrees or more above the outside temperature. On a 80 degree day, the temperature inside a vehicle can rise over a 100 degrees. A child's body can heat up three to five times faster than an adult and the child can be seriously injured or die of hyperthermia within minutes. Even if a child is found alive, irreparable brain damage can occur.

Distractions can cause a child to be left in a vehicle. Forgetfulness has occurred due to stress, lack of sleep, and distractions. Children have died because their parents and/or caregivers are distracted or think their children are elsewhere. People need to take steps to remember not to leave a child in a vehicle. A simple and timely audio reminder is very effective in getting the immediate attention of those who are momentarily forgetful and/or distracted.

Prior art consists of a system dependant upon leaving a child in a vehicle to set off an alarm. Other prior art combines recording devices and motion sensor to trigger the device to record upon motion, and do not serve the intended primary purpose as a reminding device.

### ADVANTAGES AND SUMMARY OF INVENTION

A need exists for an effective system and method of use to help people, timely, instantaneously with messages or series of messages. The built into a vehicle reminder can help the driver in forming safety habits, and in remembering. The portable reminder can be used inside a vehicle, home, office, and school. It can help with forming a safe habit, help facilitate learning, help in communication, help the blind receive a message, and even alert a pet owner.

One object and advantage of the present invention is to provide a reminder message each time the ignition or driver's door handle is reached for or touched or door is opened.

Another object and advantage of the present invention is to aid in reminding the driver to look for the child and remove the child from the vehicle, to help in forming a safe habit, and thus prevent a tragedy.

Another object and advantage of the present invention is to help aid a person in remembering what they want to get done. It can be used to plan their day.

Another object and advantage of the present invention is when the portable device is placed near a door in the house, the device can help alert a pet owner, the animal is near the door and needs to go out or come in. Another objective of the invention is to help a person receive a message when a note is not expected or has not been found in the past.

Another object and advantage of the present invention is to help the blind or the visually impaired receive a message each time the motion detector is triggered by someone walking near by.

Further details, objects and advantages of the present invention will become apparent through the following descriptions, and will be included and incorporated herein.

### BRIEF DESCRIPTION OF THE DRAWINGS

FIG. 1 is a representative schematic block diagram of one embodiment of personal reminder 100 of the present invention.

FIG. 2A shows a representative view of configuration of one embodiment of personal reminder 100 of the present invention installed adjacent to the ignition of a motor vehicle.

FIG. 2B shows a representative view of configuration of one embodiment of personal reminder 100 of the present invention installed adjacent to the car door handle or the driver's door.

For a better understanding of the invention reference is made to the following detailed description of the preferred embodiments thereof which should be taken in conjunction with the prior described drawings.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

For a better understanding of the invention reference is made to the following detailed description of the preferred embodiments thereof which should be taken in conjunction with the prior described drawings.

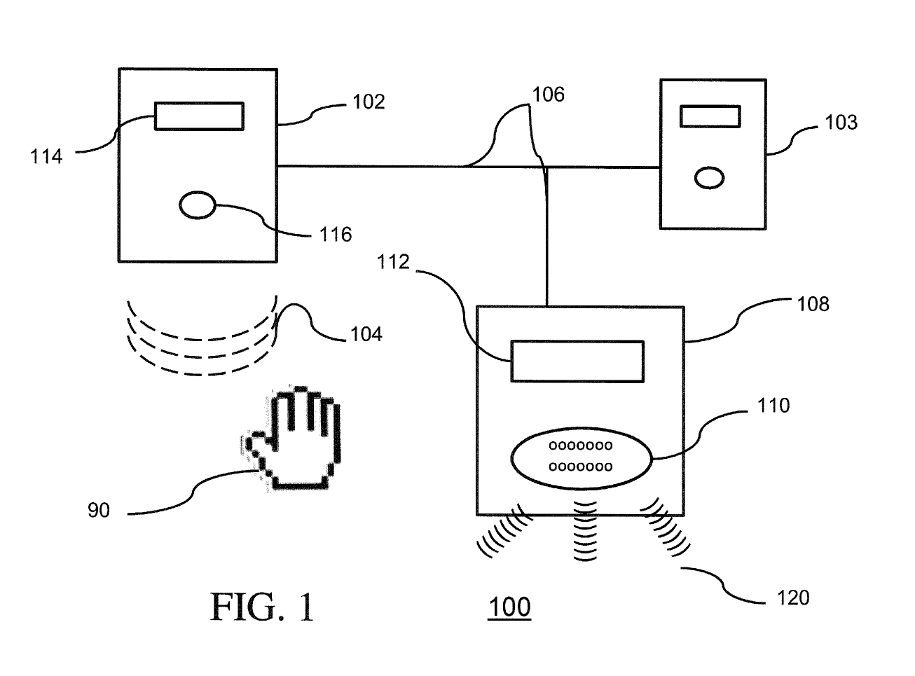

FIG. 1 is a representative schematic block diagram of one embodiment of personal reminder system 100 of the present invention. As best shown in FIG. 1, personal reminder system 100 of the present invention consists mainly motion sensor(s) 102 that triggered by motion within its detecting range, connecting system or device 106 and alarm and recorder/playback device 108. In one alternative embodiment, some or all motion sensor(s) 102 can be replaced with touch sensor(s) 103 such that touch sensor 103 will only be triggered by actual physical contact.

In one embodiment, motion sensor(s) 102 can be either active, passive or a combination thereof. For example, it can be a passive infrared sensor which senses body heat and no energy 104 is emitted, an active ultrasonic sensor which sends out energy 104 such as pulses of ultrasonic waves and measures the reflection off a moving object, or an active microwave sensor that sends out microwave pulses and measures the reflection off a moving object which is similar to a police radar gun, and/or an active tomographic sensor that senses disturbances to radio waves as they travel through an area surrounded by mesh network nodes. Many modern motion detectors use a combination of different technologies. Combining multiple sensing technologies into one detector can help reduce false triggering. Many dual-tech sensors combine both a PIR sensor and a microwave sensor into one unit, so in order for motion to be detected, both sensors must trip together, lowering the probability of a false alarm, since heat and light changes may trip the PIR sensor, but not the microwave sensor.

In one embodiment, the ideal motion sensor(s) 102 of the present invention 100 is a low range motion sensor, since it is designed to be triggered by the driver's hand 90 when it gets close to the motion sensor 102. Users can optionally install one or more motion sensors 102 at strategic locations in or on the vehicle, so that a message alerts them, when entering and exiting the vehicle. In this particular embodiment, the low range motion sensor(s) 102 can be in the approximate range of less than 1 inch, or 1 inch or 2 inch, or 3 inch, or 4 inch, or 5 inch, or 6 inch range depending upon its location. When near an ignition the low range motion sensor 102 has to be in a low enough range and situated so that driver's hand 90 can trip the motion sensor 102 when driver reaches for or touches the ignition and so that the motion sensor 102 is not triggered by swinging keys, or other random movements. When the low range motion sensor 102 is near the driver's door handle, the motion sensor 102 has to be in a low enough range and situated where driver's hand 90 in grabbing the driver's door handle can trigger the motion sensor 102 but not triggered by driver resting his arm on the arm rest. Alternatively, touch sensors 103 can also be connected to the ignition and/or driver's door to trigger recorder/playback device 108 and activate reminding messages 120 when the ignition is turned on or off or driver's door is opened. For example, a touch sensor 103 located to trigger recorder/playback device 108 to play a reminding message 120 when the driver's door is opened. The personal reminder system of the present invention 100 can help create a habit of looking for the child(ren) and removing the child(ren) from the vehicle, thus help in preventing tragedy.

In one alternative embodiment, the portable personal reminder system 100 can have both low and high range motion sensors 102 built into the system 100, or extended beyond the system 100, with the high range motion sensor 102 having a range of several feet. In one embodiment, the personal reminder system 100 with its motion sensor(s) 102 and touch sensor 103 can be portable, battery operated, plug in rechargeable, and/or built into a vehicle. There is an on/off switch 112 so the personal reminder system 100 can be switched off as users desire. Optionally there is an on/off switch 114 in motion sensor(s) 102 and touch sensor(s) 103 such that personal reminder system 100 can be switched off as users desire. Optionally, there is a LED light 116 in motion sensor(s) 102 and touch sensor(s) 103 such that when motion sensor(s) 102 and touch sensor(s) 103 is triggered, the LED light 116 will be on and/or flashing to add as an additional visual reminder to users.

Once the motion sensor(s) 102 or touch sensor 103 is triggered, it will send a signal to the recorder/playback recording device 108 via connecting device 106. In one embodiment, motion sensor(s) 102, touch sensor 103 sends out a signal when it is triggered. The signal can be electrical, electronic and/or electro-magnetic such as radio wave, microwave, etc. In one embodiment, connecting device 106 can be electrical wiring that connects motion sensor(s) 102, touch sensor(s) 103 to recorder/playback device 106. In one particular embodiment that motion sensor(s) 102, touch sensor(s) 103 give out radio or microwave, connecting device 106 can be eliminated.

In one embodiment, recorder/playback device 108 is a digital recorder/player which allows users to record message(s) which will be played back when recorder/playback device 108 receives a signal from motion sensor(s) 102 and/or touch sensor(s) 103. In one embodiment, recorder/playback device 108 further consists of speaker 110, a switch on/off and manual control assembly for forward, reverse, play, record, erase, etc. functions, a power source hardwired for use in the vehicle only or battery powered, rechargeable battery or batteries with a plug and cord for recharging batteries, or a plug to plug into the wall or the vehicle. Users can record a single message, a series of messages and/or music 120 to customize to their own needs. Recorder/playback device 108 can play the same message 120 each time motion/touch triggers it and/or it can play a series of messages, each one playing separately, each message individually triggered by motion/touch. In other words, it can be equipped with an option to play one or several messages individually triggered by motion/touch, which ever users choose.

In one alternative embodiment, recorder/playback device 108 has multiple channels which further consists of different pre-recorded messages and/or user recorded messages. Each channel is triggered by a different motion sensor 102 and/or touch sensor 103. For example, users can install one motion sensor 102 and/or touch sensor 103 adjacent to the ignition and another motion sensor 102 and/or touch sensor 103 near the door handle and/or the driver's door such that they will be triggered by the turning of the ignition and/or opening of the driver's door. Each motion sensor 102 and/or touch sensor 103 will trigger a different channel in the recorder/playback device 108, hence a different message will be played. In yet another embodiment, recorder/playback device 108 can simply be users' mobile phones, when motion sensor(s) 102 and/or touch sensor(s) 103 is triggered, it will subsequently trigger users' mobile phones to ring, play out a message, vibrate, etc. to suit users' own specific needs.

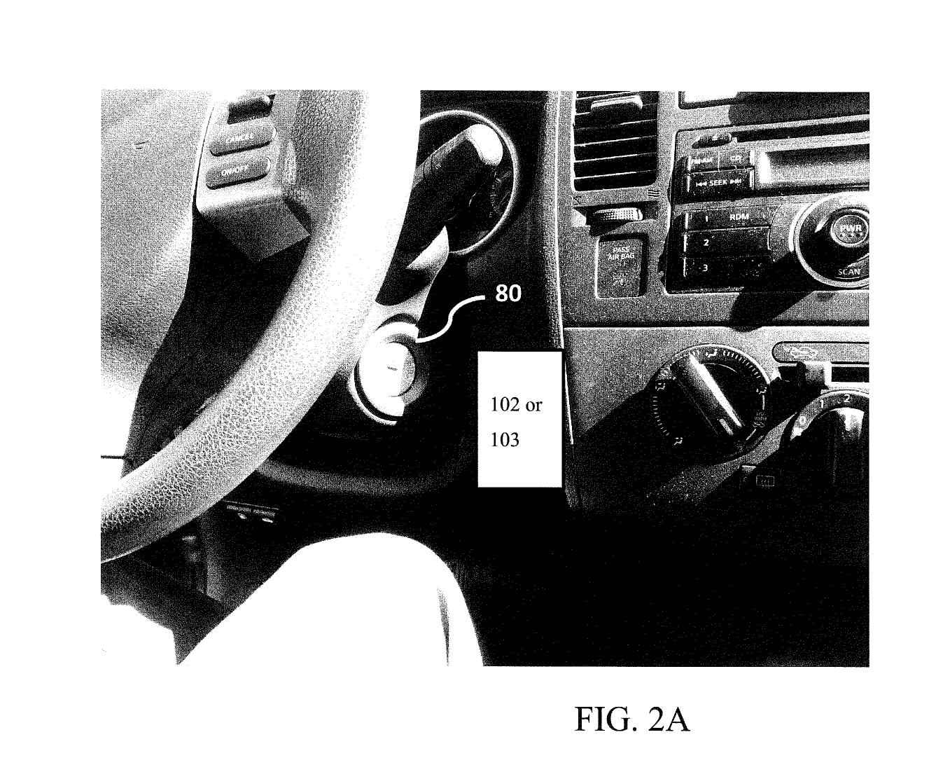

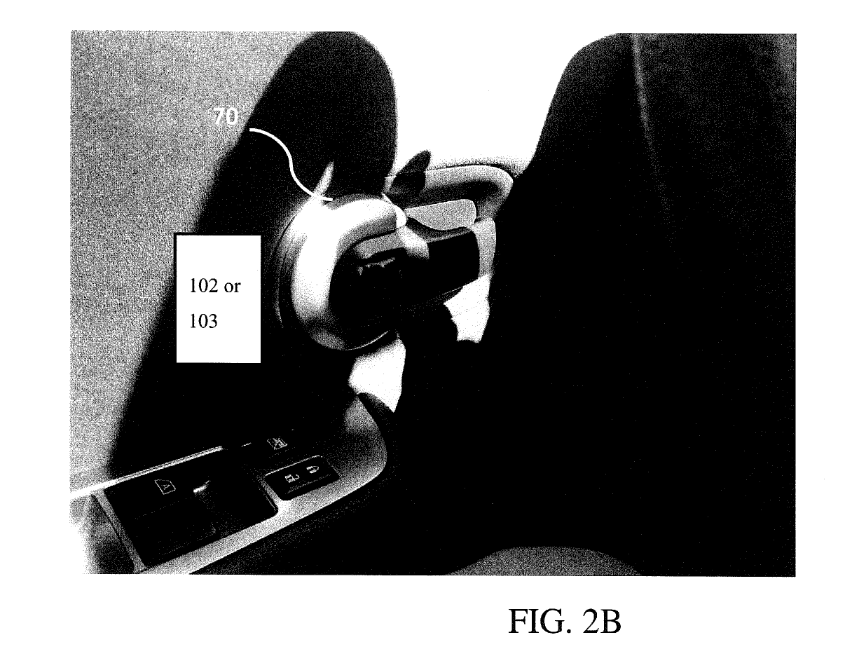

FIG. 2A shows a representative view of configuration of one embodiment of personal reminder 100 of the present invention installed adjacent to the ignition. As best shown in FIG. 2A, motion sensor 102 and/or touch sensor 103 is installed adjacent to ignition 80 of a vehicle. Whenever users reach for the ignition 80, either to start or turn off the engine, the motion will trigger motion sensor 102 and/or touch sensor 103. The signal will then be transmitted via connecting device 106 [not shown] to recorder/playback device 108 [not shown]. The recorder/playback device 108 will then be turned on and reminding message(s) 120 will be played. In one embodiment, when users reach for the ignition to turn off their vehicle, recorded safety message(s) will be played to warn users not to leave their child(ren) unattended in their vehicle. Since users can decide what messages to record, for example, it can either be “Look for the child. Please remove child from vehicle.”, or multiple messages can be recorded and will play each time users reach for the ignition. They can even be personal messages, motivational messages, songs, and lullabies. The present invention can be deemed a safety device because it gives safety messages. For example, when users reach for the ignition to start their vehicle, the played safety messages can be, “Make sure your child is safe and secured before moving the car”, which can help prevent roll-over deaths which occur while a car or other vehicle is backing up. Other safety warnings can also be incorporated, to make sure a child is safe and secure before starting the vehicle to prevent a roll over death.

FIG. 2B shows a representative view of configuration of one embodiment of personal reminder system 100 of the present invention installed adjacent to the car door handle or the driver's door. As best shown in FIG. 2B, motion sensor(s) 102 and/or touch sensor(s) 103 is installed adjacent to door handle 70 of a vehicle. Whenever users reach for the door handle 70, either to open or close the door, the motion will trigger motion sensor(s) 102 and/or touch sensor(s) 103. In alternative embodiment, motion sensor(s) 102 and/or touch sensor(s) 103 [not shown] can be installed at door handles in the back seat so when a child tries to open the door, it will trigger motion sensor motion sensor(s) 102 and/or touch sensor(s) 103 and a stern warning to the users can be played such as “Lock your car doors when in motion”, “Your child is trying to open the car door.”, etc.

In one embodiment, users can either use motion sensor(s) 102 and/or touch sensor(s) 103 adjacent to the door handle on its own or use it in combination with another motion sensor(s) 102 and/or touch sensor(s) 103 adjacent to the ignition. Different messages 120 can be played by triggering different motion sensor(s) 102 and/or touch sensor(s) 103 if a multi-channel recorder/playback device 108 is used.

In summary, by having a multi-channel recorder/playback device 108 and placing motion sensor(s) 102 and/or touch sensor(s) 103 at strategic locations in/on their vehicles and recording different message(s) 120 for each channel, users can record their own personal messages 120 and customize personal reminder system 100 of the present invention to suit their own specific needs.

Other Applications:

In alternative embodiments, the personal reminder system of the present invention 100 can be configured differently for applications other than children safety in vehicles. The basic principal of the present invention 100 is that a motion will trigger playing back of personal messages.

In one alternative embodiment, the reminder device with its high/low range motion sensors can be placed near the main entrance of a house, reminding messages can be recorded, then triggered to play via the motion sensors every time users go in or out of the house. It can be used to remind users to turn off lights, stove, etc. for safety and energy conservation. The present invention 100 can work for pet owners as well. A reminding message is played each time the pet gets near the door. The reminding message reminds users their pet needs to go out. It helps prevent soiling in the house. Alternatively, a motion detector can be triggered by the pets that get near the outside door. The message can be, “Someone's here.” It can be used for anyone approaching the door.

In yet another alternative embodiment, the portable reminding device with its high/low range motion sensor(s) can be placed at a common gathering area such as the kitchen counter or near the refrigerator. When users walk near and trigger the motion sensor, a reminding message is played. It can be used to help plan someone's day, to prevent someone from forgetting, to remind someone to stick with a diet plan, and used in studying such as trying to remember a foreign language. Since playback device is portable and messages can be recorded and programmed as users desire, messages can go back and forth with family members, roommates, faculty, business partners, etc.

In yet another embodiment, the present invention can be paired with other objects, such as keys, and mobile phones. Place them together where the motion sensor can trigger the message. So if you are in a hurry and you momentarily cannot remember where you set them down, the reminder will tell you when you walk by triggering the motion sensor.

In yet another embodiment, the present invention can help the blind or visually impaired receive a message, each time the motion sensor is triggered. The motion sensor can be triggered by someone walking by it. The reminder can be used for affirmations. motivations. and pep-talks.

In yet another embodiment, the present invention can be used to play a child's game. Place motion sensor(s)/reminder device(s) somewhere in the house and have the child look throughout the house to find it/them. Finding it is dependent upon setting off the motion detector. Take turns placing it and finding it. Rule: The device must be placed where it could be triggered by motion. Message can be: “You found me.” You can erase and record something else to have a new message as a surprise each time it is found. Or have the reminder give further directions, like part of a treasure hunt. When the child finds the reminder, it could say, “You found me. Now go find the toy on the window sill” The directions can become more complicated as the child gets older, such as, “Find the big red dot, in the book, on the table in the kitchen. Place it by the front door, then you can have some ice cream.” Every time the motion sensor is triggered, the message plays. The child will get to hear the request several times and eventually be able to follow the directions. For the littlest child, place the reminder somewhere, then tell the child exactly where it is. Such as, “It's beside the bookcase.” or “It's under the table.” When the child finds it, the reminder can say, where it is, such as, “I′m beside the bookcase.” or “I′m under the table.” The reminder games can help a child with understanding and following directions, as well as language acquisition.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, they will be immediately obvious to those skilled in the art and include many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A method for enhancing children's safety in a vehicle utilizing a personal reminder system, the method comprising the following steps:
obtaining the personal reminder system further having one or more short-ranged motion detectors, the motion detectors triggered and sending out electrical signal, via electrical connection means, to a digital audio recording and playing device, the digital audio recording and playing device switched on by the motion detector and playing recorded reminding messages;
recording children safety theme reminding messages on the digital audio recording and playing device;
disposing the motion detectors adjacent to ignition and driver's door handle, whereof drivers' hand to trigger said motion detectors while turning on and off of the engine and getting in and out of the vehicle;
being reminded of children's presence when turning on and off the engine or getting in and out of the vehicle; and
taking children out of the vehicle when leaving.

2. The method for enhancing children's safety in a vehicle utilizing a personal reminder system of claim 1 further comprising the step of:
obtaining one or more touch sensors, replacing one or more of the motion detectors with the touch sensors, the touch sensors triggered and sending out electrical signal, via electrical connection means, to the digital audio recording and playing device, the digital audio recording and playing device switched on by the touch sensor and playing recorded reminding messages.

3. The method for enhancing children's safety in a vehicle utilizing a personal reminder system of claim 2 further comprising the step of disposing the touch sensor at driver's door, the touch sensor triggered when the driver's door is opened and closed.

4. A personal reminder system for reminding drivers to care for their children on board, the personal reminder system comprising:
one or more motion detectors having a predetermined range, the motion detectors installed adjacent to strategic locations inside the vehicle whereof drivers' hand to trigger said motion detectors while turning on and off of the vehicle and getting in or out of the vehicle;
connecting means to transmit electrical signal from the motion detector when triggered by motion of drivers' hand; and
a digital audio recording and playing device connected to the motion detectors by the connecting means, turned on and playing recorded reminding messages by the electrical signal transmitted from the motion detector.

5. The personal reminder system of claim 4 further comprising one or more touch sensors, the touch sensors to replace one or more of the motion detectors.

6. The personal reminder system of claim 4 in which the predetermined range of the motion detectors are in the approximate range of 0 inch to 7 inches.

7. The personal reminder system of claim 4 in which the motion detectors are selected in the following group of:
passive infrared detector, active microwave detector, active ultrasonic detector, active Tomographic detector and combinations thereof.

8. The personal reminder system of claim 4 in which the connection means is an electrical wiring.

9. The personal reminder system of claim 4 in which the strategic locations are the car ignition and the driver's door handle, the driver's door and the back seat door handles.

10. The personal reminder system of claim 4 in which the recorded messages are in the theme of children safety and of not leaving unattended children inside the vehicle.

11. The personal reminder system of claim 4 in which the digital audio recording and playing device further having multiple channels, each channel having a different recorded message, triggered by the signal sent by each different motion detector and touch sensor.

12. A method of use of a portable, personal, customizable reminder system, the customizable reminder system comprising one or more motion detectors having a predetermined range of activation, the motion detectors being installable adjacent strategic locations where activation of the sensors by detection of motion is possible, connecting means to transmit electrical signal from the motion detector when triggered by motion, and a digital audio recording/playing device connected to the motion detectors by the connecting means, the audio recording/playing device further comprising recorded reminding messages, the method of use comprising the following steps:
positioning the one or more motion sensors in locations where detection of motion is likely;
inputting specific recorded audio data to the audio recording/playing device; and
activating the reminder system such that upon sensing of motion by one or more of the motion sensors, the audio recording/playing device will play back the specific recorded audio data, thereby providing a personal reminder as desired.

13. The method of claim 12, wherein the motion sensors are placed into locations on a car, the specific recorded audio data comprises a reminder not to leave a child unattended in a vehicle, and the audio recording/playing device is activated when the motion sensors sense motion.

14. The method of claim 13, wherein the motion sensors are placed adjacent the ignition switch and/or the handles of the doors of the car, and the audio playing device is activated when the motion sensors sense motion of the driver's hand adjacent the handles of the door or the ignition switch.

15. The method of claim 13, wherein the motion sensors replaced by touch sensors, the touch sensors triggered by physical contact with the driver's hand.

16. The method of claim 12, wherein the motion sensors are placed into locations near the door of a house, the specific recorded audio data comprises a reminder that a pet needs to go outside of the house, and the audio playing device is activated when the sensors sense motion.

17. The method of claim 12, wherein the motion sensors are placed adjacent doors in a house, and the audio playing device is activated when the sensors sense motion of a pet in the proximity of the motion sensor.

18. The method of claim 12, wherein the motion sensors are placed adjacent doors in a house, and the audio playing device is activated when the sensors sense motion of a pet in the proximity of the sensor.

19. The method of claim 12, wherein the recorded audio data comprises a single reminder message.

20. The method of claim 12, wherein the recorded audio data comprises a series of related reminding messages.

21. The method of claim 12 in which the motion sensors are positioned where they are likely to detect motion in a house, office, vehicle or other location, and the recorded audio data comprises one or more schedule and/or calendar items, such that upon activation of the motion sensors, the recorded audio data reminds about a schedule or calendar deadline.

22. The method of claim 12, wherein the motion sensors are placed adjacent doors on the exterior of a house, the recorded audio data consists of a notification that an individual has approached a house, and the audio recording/playing device is activated when the motion sensors sense motion of an individual approaching the exterior of the door of the house.

23. The method of claim 12, wherein the motion sensors are placed adjacent locations frequented by blind individuals, the recorded audio data consists of a notification that an individual has approached, and the audio recording/playing device is activated when the motion sensors sense motion of an individual approaching the sensor.

24. The method of claim 12, wherein the reminder system further comprises means for pairing the motion sensors with a cell phone, set of keys or other personal property, and the audio recording/playing device is activated when the motion sensors sense motion of an individual approaching the sensor, thereby indicating the location of the cell phone, set of keys or other personal property.

25. The method of claim 12, wherein the recorded audio data comprises sets of instructions or commands for education or training of children, and the audio recording/playing device is activated when the motion sensors sense motion of a child approaching the sensor, thereby allowing compliance by the child with the instructions or commands.
